(19) United States
(12) Patent Application Publication
(10) Pub. No.: US 2012/0193852 A1
(43) Pub. Date: Aug. 2, 2012

(54) DAMPER BEARING WITH PROFILED INSERT

(75) Inventor: Frank THYE-MOORMANN, Lembruch (DE)

(73) Assignee: BASF SE, Ludwigshafen (DE)

(21) Appl. No.: 13/359,678

(22) Filed: Jan. 27, 2012

Related U.S. Application Data
(60) Provisional application No. 61/437,020, filed on Jan. 28, 2011.

(51) Int. Cl. B60G 11/22; F16F 1/36

(52) U.S. Cl. 267/292

(57) ABSTRACT

A damper bearing (10) comprising a substantially hollow cylindrical damping element (20, 22, 24, 26), based on cellular polyisocyanate polyaddition products, and an insert (30), which is at least partially enclosed by the damping element (20, 22, 24, 26) in the radial direction and axial direction, wherein the insert (30) has, on at least one axial face connected to the damping element (20, 22, 24), a profile (32) with depressions and/or elevations.

The present invention relates to a damper bearing comprising a substantially hollow cylindrical damping element, based on cellular polyisocyanate polyaddition products, and an insert, which is at least partially enclosed by the damping element in the radial direction and axial direction. The invention further relates to automobiles, for example passenger vehicles, trucks or buses, which contain damper bearings according to the invention.

Damper bearings made from polyurethane elastomers are used within the chassis of automobiles and are generally known, for example from DE 10 2004 027 904 A1, DE 10 2005 009 667 A1 or DE 10 2007 011 209 A1. They are used in automobiles in particular as vibration-damping suspension elements. The suspension elements thereby undertake the connection of the shock absorber to the body and/or to components of the chassis.

Such a coupling has the effect of damping, decoupling or isolating vibrations that are caused by the roadway and passed on via wheel and shock absorber, and also vibrations caused by the shock absorber itself. The coupling is configured such that cardanic movements of the shock absorber are made possible and the requirements as regards force/travel characteristics are fulfilled. Depending on the chassis design, these characteristics significantly influence the driving behavior and must be made to match exactly the respective type of vehicle or the vehicle components to be decoupled. The interaction of shock absorber and damper bearing ensures the following functions:
driving comfort
driving safety
roll/pitch support
reduction of effects of wheel jolt and body tremble.

In the damper bearings known from the prior art, insert and damping element move relative to each other on account of the mechanical load, thus causing shearing or abrasion of the damping element. This has the effect that the damping elements are mechanically damaged and the useful life of the component is greatly reduced.

It was an object of the invention to provide damper bearings that better withstand the high loads occurring in a chassis and that have a longer useful life.

This object is achieved by the subject matter of the invention as set forth in claim 1. Other advantageous embodiments of the invention can be found in the dependent claims. The invention also relates to automobiles containing one or more of the damper bearings according to the invention.

According to the invention, the damper bearing comprises a substantially hollow cylindrical damping element, based on cellular polyisocyanate polyaddition products, and an insert. The insert is at least partially enclosed by the damping element in the radial direction and axial direction. Hereinafter, the terms “longitudinal axis”, “axial”, “above” and “below” designate the orientation in which damper bearings of this kind are usually mounted, e.g. in the chassis of an automobile. A “longitudinal section” is understood as a section parallel to the longitudinal axis, and a “cross section” is understood as a section perpendicular to the longitudinal axis. The word “radial” designates a direction, in the cross-sectional plane, away from or toward the longitudinal axis.

The insert has, on at least one axial face connected to the damping element, a profile with depressions and/or elevations. An elevation is to be understood as a continuous partial surface protruding in the axial direction from the end surface. Analogously, a depression is to be understood as a continuous partial surface extending in the axial direction into the end surface. Surface irregularities caused by roughness, usually in the range of 0 to 50 micrometers and mainly production-related, are disregarded in the definition of elevations and depressions.

In one embodiment according to the invention, the insert is shaped as a disk, preferably as a circular disk. The insert preferably has, at the center of the disk, a hole through which, for example, the piston rod of a shock absorber can be inserted and secured. In another embodiment, the insert has an axially extending collar around the hole. The insert can be produced from known materials, preferably hard materials, for example metals, rigid plastics or composite materials. Suitable plastics are, for example, thermoplastic polyurethane, polyamide, polyethylene, polypropylene, polystyrene or, preferably, polyoxymethylene. Metals are preferably used, particularly preferably steel or aluminum, in particular aluminum.

Elevations and/or depressions can comprise individual elements which, for example, are formed as points or truncated cones, it being possible for the cross section of such a truncated cone to have different shapes, e.g. circular, oval, rectangular, square, hexagonal or octagonal.

In a preferred embodiment, the depressions comprise a plurality grooves, which do not all extend concentrically and do not all extend in parallel. The axial extent of the grooves, hereinafter also referred to as the depth of the grooves, can be constant or variable along the length thereof. The depth of the grooves is preferably substantially constant. In another preferred embodiment, the elevations comprise a plurality of webs, which do not all extend concentrically and do not all extend in parallel. The axial extent of the webs, hereinafter also referred to as the height of the webs, can be constant or variable along the length thereof. The height of the webs is preferably substantially constant.

The word “substantially” indicates here that slight deviations resulting, for example, from the manufacturing process or caused by measurement inaccuracy are disregarded. The term “concentrically” relates here, and hereinafter, to the rotation axis of a possible rotatory relative movement between the insert and the damping element. In preferred configurations according to the invention, this rotation axis extends through the center point in the sense of the geometric center of gravity of the cross-sectional surface of the insert. In the case of a circular cross-sectional surface, the center point is obvious, and, in the case of a rectangular cross-sectional surface for example, the center point is defined by the point of intersection of the diagonals.

An arrangement of the grooves and/or webs according to the two abovementioned embodiments has the effect that each radial relative movement and also a rotatory relative movement between the insert and the damping element is made difficult. In this way, the wear experienced by the component on account of abrasion of the damping element is considerably reduced.

In a preferred embodiment, the insert has, on at least one axial face connected to the damping element, a profile with a first group of parallel grooves and a second group of parallel grooves, wherein the grooves of the first group and those of the second group intersect at an angle of 30° to 90°, particularly preferably of 45° to 90°, in particular of 70° to 90°, where the angle is to be understood in each case as the acute angle.

In another preferred embodiment, the insert has, on at least one axial face connected to the damping element, a profile with a first group of parallel webs and a second group of parallel webs, wherein the webs of the first group and those of the second group intersect at an angle of 30° to 90°, particularly preferably of 45° to 90°, in particular of 70° to 90°, where the angle is to be understood in each case as the acute angle.

Of course, the invention also covers combinations of depressions and elevations. In relation to the abovementioned embodiments, for example, grooves in the first group and webs in the second group, but also a plurality of grooves and webs in each group, alternating uniformly or non-uniformly. The depressions preferably have a depth and/or the elevations a height of 0.1 mm to 1 mm, particularly preferably of 0.2 mm to 0.5 mm. In the case of elevations or depressions whose height/depth varies, the values of the preferred ranges relate to the respective minimum and maximum extents.

In a particularly preferred embodiment, the insert has, on both axial faces, a profile comprising depressions and/or elevations. In this embodiment too, it is possible for only depressions to be present, or only elevations, or depressions in combination with elevations.

A profile according to the invention with elevations and/or depressions can be produced in different ways. For example, if the insert is produced by injection molding, e.g. in the case of an insert made of plastic, the negatives of the elevations and depressions are advantageously provided in the injection mold, such that the elevations and depressions are formed upon production of the insert, and, after removal from the mold, the insert does not need to reworked any further, at least in respect of the profile. Analogously, the insert can also be produced by die casting, for example from aluminum. A profile according to the invention can also be applied to an insert subsequently. This can advantageously be done using corresponding punching or forming tools such as pressure plates. Moreover, a profile can be generated by knurling with the aid of corresponding knurling tools. Suitable tools are known to a person skilled in the art.

The external diameter of the damping element is preferably from 45 mm to 85 mm, particularly preferably from 60 mm to 75 mm, in particular from 63 mm to 68 mm. The external diameter is to be understood as the greatest distance between two mutually opposite points on the radial outer jacket surface of the damping element. Contour elements that may be present on the jacket surface, such as nubs, that project in the radial direction from the jacket surface, are disregarded.

The height of the damping element is preferably from 15 mm to 50 mm, particularly preferably from 20 mm to 35 mm, in particular from 22 mm to 28 mm. The height is understood as the distance in the axial direction between the upper face and lower face of the damping element. Any contour elements such as nubs, which project in the axial direction from the respective face, are disregarded in determining the height. The faces can be connected to each other, for example in a one-piece damping element. The faces can also belong to different individual elements, for example in the case of a multi-part damping element.

The external diameter of the insert is preferably from 40 mm to 80 mm, particularly preferably from 50 mm to 70 mm, in particular from 55 mm to 65 mm. In the area covered by the damping element, the height of the insert is preferably from 3 mm to 20 mm, particularly preferably from 5 mm to 10 mm, in particular from 6 mm to 8 mm.

In a preferred embodiment, the insert is enclosed by the damping element in the radial direction, from the outside inward, by at least 1 mm to 10 mm, particularly preferably 3 mm to 5 mm. Particularly advantageously, the insert is completely enclosed by the damping element in the circumferential direction, both in the radial direction and also in respect of the coverage in the axial direction. In this way, in the installed state of the damper bearing, acoustic bridges are avoided and undesired noise transmission is greatly reduced.

In another embodiment according to the invention, the damping element comprises at least two individual elements. In a preferred configuration, the damping element comprises three individual elements, of which one is arranged on one end face of the insert, another on the other end face of the insert, and another in the radial direction as an edge around the insert. This configuration has the advantage that the axial and radial damping properties of the damper bearing can be adapted individually and substantially independently of each other. For example, the axially arranged individual elements and the radially arranged individual element can have different hardnesses and, therefore, different damping properties. In this multi-part embodiment too, it is particularly advantageous if the insert is completely surrounded by the damping element in the circumferential direction.

Damping elements according to the invention can be produced from generally known elastic materials, for example from rubber. Damping elements according to the invention are preferably produced on the basis of cellular polyisocyanate polyaddition products, particularly preferably on the basis of cellular polyurethane elastomers, which can contain polyurea structures. In this context, cellular means that the cells preferably have a diameter of from 0.01 mm to 0.5 mm, particularly preferably from 0.01 mm to 0.15 mm.

Particularly preferably, the cellular polyisocyanate polyaddition products have at least one of the following material properties: a density according to DIN EN ISO 845 of between 200 and 1100 kg/m³, preferably between 270 and 900 kg/m³, a tensile strength according to DIN EN ISO 1798 of≧2.0 N/mm², preferably between 2 and 8 N/mm², an elongation at break according to DIN EN ISO 1798 of≧200%, preferably≧230%, particularly preferably between 300 and 700%, or a tear propagation resistance according to DIN ISO 34-1 B (b) of≧6 N/mm, preferably of 8 N/mm, particularly preferably of≧10 N/mm. In further preferred embodiments, the cellular polyisocyanate polyaddition product has two, more preferably three, of these material properties; particularly preferred embodiments have all four of the material properties mentioned.

Elastomers based on cellular polyisocyanate polyaddition products and their preparation are generally known and variously described, for example in EP 62 835 A1, EP 36 994 A2, EP 250 969 A1, EP 1 171 515 A1, DE 195 48 770 A1 and DE 195 48 771 A1.

The preparation usually takes place by reacting isocyanates with compounds that are reactive to isocyanates. In a preferred embodiment, the cellular polyurethane elastomers are prepared on the basis of the isocyanates toluene diisocyanate (TDI) and naphthalene diisocyanate (NDI), most particularly preferably on the basis of 2,6-toluene diisocyanate (TODI) and 1,5-naphthalene diisocyanate (5-NDI).

The damping elements based on cellular polyisocyanate polyaddition products are usually prepared in a mold in which the reactive starting components are reacted with one another. Conventional molds, for example metal molds, which by their form ensure the three-dimensional form according to the invention of the damping element, generally come into consideration here as molds.

The polyisocyanate polyaddition products can be prepared using generally known methods, for example by using the following starting materials in a one-stage or two-stage process:
(a) isocyanate,
(b) compounds reactive to isocyanates,
(c) water and, if appropriate,
(d) catalysts,
(e) blowing agents and/or
(f) auxiliaries and/or additives, for example polysiloxanes and/or fatty acid sulfonates.

The surface temperature of the inner wall of the mold is usually from 40 to 95° C., preferably from 50 to 90° C. The production of the molded parts is preferably carried out using an NCO/OH ratio of 0.85 to 1.20, the heated starting components being mixed and introduced into a heated, preferably tightly closing mold in an amount that corresponds to the desired density of the molded part. The molded parts are cured after 5 to 60 minutes and consequently can be demolded. The amount of the reaction mixture introduced into the mold is usually such that the moldings obtained have the density already described. The starting components are usually introduced into the mold at a temperature of from 15 to 120° C., preferably from 30 to 110° C. The degrees of compaction for producing the moldings lie between 1.1 and 8, preferably between 2 and 6.

The cellular polyisocyanate polyaddition products are expediently prepared by the one-shot process with the aid of the low-pressure technique or, in particular, the reaction injection-molding technique (RIM) in open or preferably closed molds. The reaction is carried out in particular with compaction in a closed mold. The reaction injection-molding technique is described, for example, by H. Piechota and H. Röhr in “Integralschaumstoffe” [Integral foams], Carl Hanser-Verlag, Munich, Vienna 1975; D. J. Prepelka and J. L. Wharton in Journal of Cellular Plastics, March/April 1975, pages 87 to 98, and U. Knipp in Journal of Cellular Plastics, March/April 1973, pages 76-84.

For the production of the damper bearings according to the invention, it is preferred first to place the insert into the mold, to fix it there and then to introduce the reaction mixture into the mold and allow it to cure. The inner surfaces of the mold and the surfaces of the insert not covered by the damping element are in this case preferably provided with conventional release agents, for example based on wax or silicone, or in particular with aqueous soap solutions. This ensures that the finished damper bearings can be easily removed from the mold and any removal of flash on the insert can be carried out easily.

Insert and damping element can also be produced independently of each other. The damper bearing is in this case produced by means of the insert being fitted, for example clipped, into the finished damping element. In embodiments of this kind, it is preferable if the insert is fitted with prestressing into the corresponding cutout in the damping element, in order to exploit as best as possible the advantages of the profiling on the insert. Prestressing can be obtained, for example, if the axial spacing of the cutout in the damping element is smaller than the height of the insert in the area that is located in the cutout after assembly.

The invention is explained in more detail below with reference to the drawings, which are to be understood as basic representations insofar as no concrete measurements are given. They do not limit the invention, for example with regard to actual dimensions or configurational variants of components of the damping element. In the drawings provided with measurement details, these relate to millimeters. In the drawings:

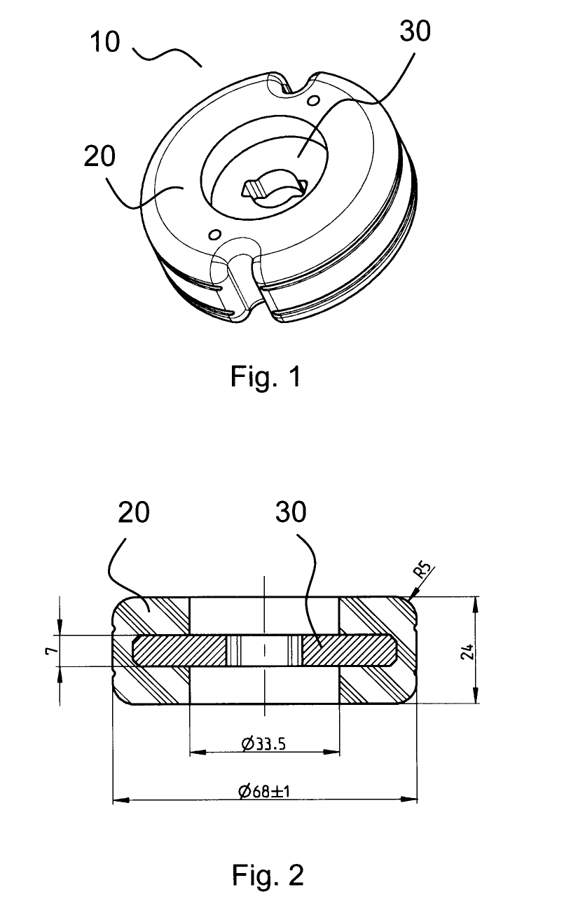

FIG. 1 shows a schematic diagram of a damper bearing according to the invention in a three-dimensional view,

FIG. 2 shows a longitudinal section through a damper bearing according to the invention,

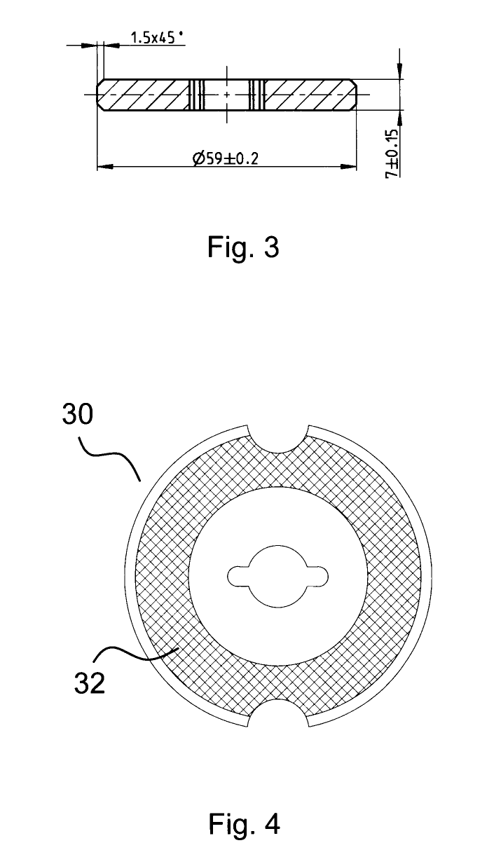

FIG. 3 shows a longitudinal section through an insert according to the invention,

FIG. 4 shows a plan view of an insert according to the invention,

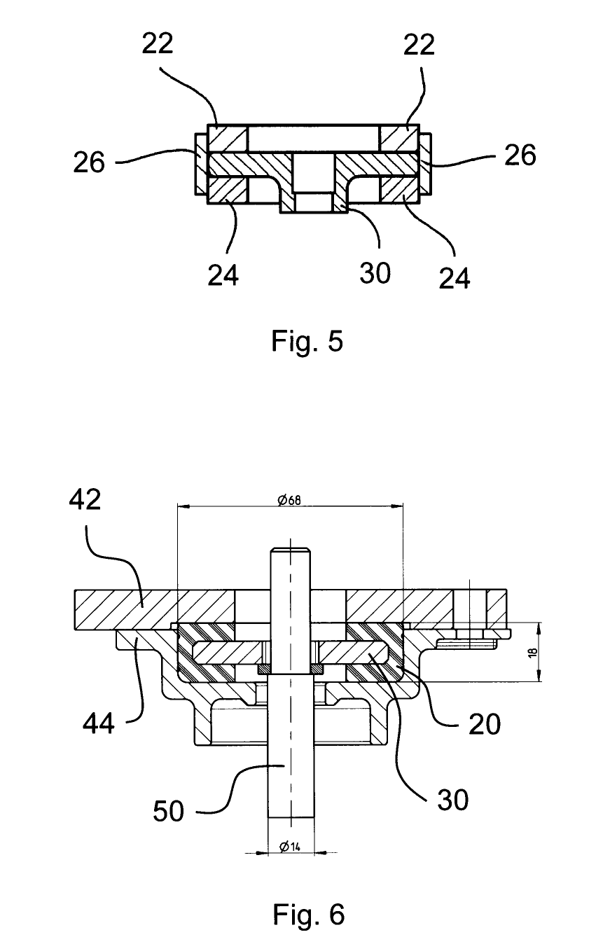

FIG. 5 shows a schematic diagram of a damper bearing according to the invention with a multi-part damping element,

FIG. 6 shows a schematic diagram of a damper bearing according to the invention in the installed state.

FIG. 1 shows a damper bearing 10 according to the invention, comprising a damping element 20 and an insert 30. The one-part damping element 20 is designed substantially as a circular hollow cylinder. On two mutually opposite sides, it has indentations in the radial outer jacket surface. In the circumferential direction, the jacket surface has two circumferential notches, which are interrupted only by the indentations. The insert 30 is arranged centrally in the damping element 20. Its outer circular edge is completely enclosed by the damping element 20.

The two indentations in this embodiment serve to protect against twisting in the installed state. The housing into which the damper bearing is installed has correspondingly arranged projections in the housing wall, such that the damper bearing is fixed in terms of rotation movements about the axis through its center point. This embodiment does not limit the invention. Damper bearings without indentations are of course also covered by the invention.

FIG. 2 corresponds to a longitudinal section through a damper bearing 10 according to the invention as per FIG. 1. The associated insert 30 is shown in detail in FIG. 3. In the example shown, the external diameter of the damping element 20 can be from 67 mm to 69 mm, with an internal diameter of 33.5 mm. The height of the damping element 20 is 24 mm. The insert 30 has an external diameter of 59 mm and a height of 7 mm. As can be seen from the sectional view, the outer edge of the insert 30 in this example is completely enclosed in the axial direction by the damping element 20. In an exactly concentric arrangement of damping element 20 and insert 30, the outer edge of the insert 30 is enclosed by the damping element 20 by 12.75 mm in the radial direction from the outside inward.

FIG. 4 shows a plan view of the face of an insert 30 according to the invention. The insert 30 has a profile 32 with a first group of parallel grooves and a second group of parallel grooves. The grooves of the first group and those of the second group intersect at an angle of approximately 90°. The transition from the outer edge of the insert 30 to the face of the latter is formed by a beveled circular surface. In the radial direction, the profile 32 extends from the beveled edge to about the halfway point of the distance from the beveled edge to the hole at the center of the insert 30. In the example shown, the insert is an aluminum insert on which a profile according to the invention has been applied by knurling according to DIN 82 RGV 1.2.

In the embodiment of a damper bearing 10 according to the invention as per FIG. 5, the damping element comprises a plurality of individual elements 22, 24, 26. In the example shown, the damping element comprises a flat circular individual element 22, which bears on the upper face of the insert 30 and encloses the outer edge thereof in the radial direction from the outside inward. Another flat, circular individual element 24 encloses the outer edge of the insert 30 on the lower face thereof, in the radial direction from the outside inward. In the axial direction, the outer edge of the insert 30 is completely enclosed by a third individual element 26.

The insert 30 is provided with a collar around the central hole, which collar extends downward beyond the lower face. The collar represents a particular configuration of the insert for receiving a piston rod of a shock absorber in the central hole. The collar is unimportant as regards the profile according to the invention on the insert and is disregarded in determining the height of the insert in the area covered by the damping elements 22, 24, 26.

FIG. 6 shows a damper bearing according to the invention as per FIG. 2, installed in a damper bearing housing of an automobile for damped suspension of a shock absorber, of which only the upper end of the piston rod 50 is shown in FIG. 6. The damper bearing housing comprises an upper, first housing part 42 and a lower, second housing part 44. The first housing part 42 can, for example, be a separate component or a part of the body of the automobile. For assembly, the piston rod is first secured on the insert 30, e.g. by screwing. The damper bearing is then inserted into the housing and the two housing parts 42 and 44 are connected to each other, specifically by screwing in the example shown. The axial extent of the housing interior in this example is 18 mm. The damping element 20 according to FIG. 2 has a height of 24 mm, such that it is prestressed in the axial direction when installed. It is likewise prestressed in the radial direction, since its diameter also increases in the event of a compression load on account of the elastic properties of the damping element 20.

In damper bearings of the type in question according to the prior art, which were used for elastic suspension of shock absorbers in automobiles, the relative movement between damping element and insert previously caused damage to the damping element. After replacement by damper bearings according to the invention, no damage was found under comparable load situations in terms of operating time and drive performance of the automobile.

The configuration, according to the invention, of the insert with a profile comprising elevations and/or depressions reduces the relative movement between insert and damping element. In this way, the useful life of the damper bearing is greatly extended. Thus, by using damper bearings according to the invention, the costs of running an automobile can be reduced and drive comfort enhanced.

1. A damper bearing (10) comprising a substantially hollow cylindrical damping element (20, 22, 24, 26), based on cellular polyisocyanate polyaddition products, and an insert (30), which is at least partially enclosed by the damping element (20, 22, 24, 26) in the radial direction and axial direction, wherein the insert (30) has, on at least one axial face connected to the damping element (20, 22, 24), a profile (32) with depressions and/or elevations.

2. The damper bearing according to claim 1, wherein the depressions comprise a plurality of grooves, which do not all extend concentrically and do not all extend in parallel.

3. The damper bearing according to claim 1, wherein the elevations comprise a plurality of webs, which do not all extend concentrically and do not all extend in parallel.

4. The damper bearing according to any one of claims 1 to 3, wherein the depth of the depressions and/or the height of the elevations are/is from 0.1 mm to 1 mm, preferably from 0.2 mm to 0.5 mm.

5. The damper bearing according to any one of claims 1 to 4, wherein the insert has, on both axial faces, a profile (32) comprising depressions and/or elevations.

6. The damper bearing according to any one of claims 1 to 5, wherein the external diameter of the damping element (20, 26) is from 45 mm to 85 mm, preferably from 60 mm to 75 mm, in particular from 63 mm to 68 mm, and the height of the damping element (20) is from 15 mm to 50 mm, preferably from 20 mm to 35 mm, in particular from 22 mm to 28 mm.

7. The damper bearing according to any one of claims 1 to 6, wherein the external diameter of the insert (30) is from 40 mm to 80 mm, preferably from 50 mm to 70 mm, in particular from 55 mm to 65 mm, and the height of the insert (30), in the area covered by the damping element (20, 22, 24, 26), is from 3 mm to 20 mm, preferably from 5 mm to 10 mm, in particular from 6 mm to 8 mm.

8. The damper bearing according to any one of claims 1 to 7, wherein the damping element (20, 22, 24) encloses the insert (30) in the radial direction, from the outside inward, by at least 1 mm to 10 mm, preferably 3 mm to 5 mm.

9. The damper bearing according to any one of claims 1 to 8, wherein the damping element (22, 24, 26) comprises at least two individual elements.

10. An automobile containing damper bearings according to any one of claims 1 to 9.
